(19) United States
(12) Patent Application Publication
(10) Pub. No.: US 2009/0140510 A1
(43) Pub. Date: Jun. 4, 2009

(54) Porous igniter coating for use in automotive airbag inflators

(76) Inventors: Ivan V. Mendenhall, Providence, UT (US); David W. Parkinson, North Ogden, UT (US)

Correspondence Address: AUTOLIV ASP, INC;Attn: Sally J. Brown ESQ, 3350 Airport Rd, OGDEN, UT, 84405, US

(21) Appl. No.: 12/290,081

(22) Filed: Oct. 27, 2008

Related U.S. Application Data
(62) Division of application No. 10/726,313, filed on Dec. 2, 2003, now abandoned.
Application No. 10/726,313 is a continuation-in-part of application No. 10/313,819, filed on Dec. 6, 2002, now Pat. No. 6,843,869.
Application No. 10/313,819 is a continuation-in-part of application No. 10/359,962, filed on Feb. 6, 2003, now abandoned.

(51) Int. Cl. B60R 21/26; B32B 37/14

(52) U.S. Cl. 280/741; 156/78

(57) ABSTRACT

An ignition composition effective to form a porous igniter substance capable of adhering to an associated inflator apparatus surface for use in an automotive inflatable restraint system and a method for preparing a porous igniter coating formed from the ignition composition are provided. The ignition composition includes a fuel, an oxidizer, a polymeric binder and a blowing agent effective, upon decomposition, to increase the surface area of the porous igniter substance. The porous igniter substance or coating is formed by heating the ignition composition to a predetermined temperature.

### CROSS REFERENCE TO RELATED APPLICATIONS

This application is a divisional patent application of U.S. application Ser. No. 10/726,313, filed on 2 Dec. 2003, which is a continuation-in-part of U.S. application Ser. No. 10/313,819, filed on 6 Dec. 2002 and a continuation-in-part of U.S. application Ser. No. 10/359,962 filed on 6 Feb. 2003. The co-pending parent applications are hereby incorporated by reference herein in their entirety and are made a part hereof, including but not limited to those portions which specifically appear hereinafter.

### BACKGROUND OF THE INVENTION

This invention relates generally to an ignition composition for use in an inflator apparatus for an inflatable restraint system. More particularly, this invention relates to an ignition composition which, upon being heated to a predetermined temperature, forms a porous igniter substance which desirably adheres to an associated inflator apparatus surface.

It is well known to protect a vehicle occupant using a cushion or bag, e.g., an “airbag cushion” that is inflated or expanded with a gas when a vehicle experiences a sudden deceleration, such as in the event of a collision. Such airbag restraint systems typically include: one or more airbag cushions, housed in an uninflated and folded condition to minimize space requirements; one or more crash sensors mounted on or to the frame or body of the vehicle to detect sudden deceleration of the vehicle; an activation system electronically triggered by the crash sensors; and an inflator device or apparatus that produces or supplies a gas to inflate the airbag cushion. In the event of a sudden deceleration of the vehicle, the crash sensors trigger the activation system which in turn triggers the inflator device which begins to inflate the airbag cushion in a matter of milliseconds.

Many types of inflator devices have been disclosed in the art for use in inflating one or more inflatable restraint system airbag cushions. Many prior art inflator devices include a solid form of gas generant material which is burned to produce or form gas used in the inflation of an associated airbag cushion.

Such inflator devices tend to involve a chain of reactions of materials, e.g., pyrotechnics, contained within an inflator device to produce or generate an inflation medium, e.g., inflation gas, to result in the deployment of an airbag cushion. For example, such devices commonly employ a squib or initiator that is electronically ignited when a collision is sensed. The discharge from the squib in turn ignites an ignition material or composition generally positioned in close proximity to the squib. The ignition material desirably burns relatively rapidly, with a large caloric output, such as to desirably ignite a supply of gas generant material. The gas generant material in turn burns to produce or form gas such as is directed into an associated airbag cushion to effect inflation thereof. In general, the ballistic properties of a gas generant material are controlled by the shape (usually tablets or wafers) and burn rate of the gas generant material.

As will be appreciated, rapid and repeatable ignition of a gas generant material is critical to providing inflator devices that enable an airbag cushion to reliably deploy in the very short period of time associated with vehicle occupant passive restraint systems. For example, inflator designers typically require the period of time following activation of the system until gas is expelled from an inflator to be less than 3 milliseconds.

Inflator designs that attempt to incorporate, by simple blending or mixing together, an igniter powder with gas generant tablets, wafers or other gas generant particle shapes have generally not proven successful. In particular, igniter powders in such inflator designs tend to be susceptible to migration away for the squib and gas generant particles over time. Consequently, such designs may experience unacceptable delays and produce or result in less than optimal occupant protection.

In view thereof, conventional inflator devices have commonly included some form of ignition material packaging to ensure proper placement and positioning of the ignition material within the inflator device to effect desired ignition and reaction of the associated gas generant material. More specifically, it is common for inflator devices to include a powdered ignition material that is packaged within a separate container in close proximity to the squib and the gas generant particles. In such an arrangement, the squib is able to rapidly ignite the ignition powder which in turn causes the rapid ignition of the gas generant material.

In practice, the packaging of such ignition materials can be relatively simple and straightforward such as by packaging the ignition material in a small canister, such as an aluminum canister, in the center of a toroidal-shaped driver inflator or relatively complex such as by packaging the ignition material in a tubular device which in turn is inserted down a bore of a stack of gas generant wafers in typical, cylinder-shaped passenger inflator device. Regardless of the specifics of such designs, the packaging of a powder ignition material within an inflator device has typically required the inclusion of additional parts and added weight.

As will be appreciated, space is often at a premium in modern vehicle designs. Consequently, it is generally desired that the space requirements for various vehicular components, including inflatable vehicle occupant restraint systems, be reduced or minimized to as great an extent as possible. The incorporation of an igniter assembly such as described above and associated support structure(s), may require a larger than desired volume of space within an associated inflator device. In particular, such volume of space could alternatively potentially be utilized to store or contain gas generant material, and thereby permit the volume of space required by the inflator device to be reduced.

In addition, the incorporation and use of an ignition assembly and process such as described above, can detrimentally impact either or both the weight and cost of the corresponding apparatus hardware.

Thus, there is a need and a demand for alternative airbag inflator device ignition schemes and, in particular, a need and a demand for avoiding the requirement or inclusion of separate ignition composition charges housed in associated hardware.

In an alternative approach, an ignition composition has been pressed into a particle shape with similar dimensions as the gas generant particles and to strategically position these igniter particles within the gas generant mass in close proximity to the squib. Specific examples of this approach include: ignition material wafers placed or positioned at the end of a gas generant wafer stack next to a squib or placed with periodicity along the length of a gas generant wafer stack; ignition material tablet(s) placed or positioned at the squib end of a bed of gas generant tablets in a side impact inflator; ignition material tablets placed down the bore of a gas generant wafer stack; ignition material tablets placed in the center of a bed of gas generant tablets in a toroidal driver inflator; or similar concepts. Unfortunately, pressed ignition particles typically present a greatly reduced surface area as compared to a similar mass of ignition powder. As will be appreciated, a reduced surface area of the ignition material during combustion will typically result in a reduced rate of energy release and may, thus, cause or result in undesired delays within an airbag inflator device.

Thus, is also a need and a demand for ignition materials having a surface area similar to those of powdered ignition materials.

In another approach, an ignition composition may be applied or coated onto a surface of an inflator apparatus such as, for example, on a surface of a gas generant material, on an interior surface of an inflator device, on a surface of an electrical squib, on a surface of a damper pad, or combinations thereof. For example, Mendenhall et al., U.S. Pat. No. 6,077,372 issued Jun. 20, 2000 discloses an ignition enhanced gas generant formulation and method of making the same utilizing a solvent effective to partially solubilize at least one component of each of a selected ignition composition, and upon application to the gas generant, at least one component of an associated gas generant. Parkinson et al., U.S. Pat. No. 6,527,297 issued Mar. 2, 2003 discloses applying an ignition composition including a silicone resin additive effective to adhere the ignition composition to inflator apparatus surfaces such as damper pads.

While such ignition composition coatings may be effective in overcoming or minimizing various shortfalls of prior ignition assemblies and processes, further particular improvements have been sought and desired. For example, it is generally desired that a coating of ignition material strongly adhere to an associated inflator apparatus surface such that the ignition material does not readily or easily separate from the surface either during handling or when subjected to normal vibration such as may be experienced by an inflator device during its lifetime in an automotive vehicle. Increasing the adhesion of the ignition material can be accomplished by incorporating a soluble polymeric binder material into a slurried ignition composition that upon drying forms a film that imparts a cohesiveness to the ignition material and an adhesive physical bond to an associated surface. The degree of adhesion is generally directly proportional to the level of polymeric material in the ignition composition. However, a decrease in performance of the ignition material, as manifested by an increased delay ignition of the igniter material, has been observed as the level of polymeric material is increased in the ignition composition. It is believed that such loss of performance is likely attributable to a reduction of igniter material surface area resulting in a loss of mass burning rate.

Thus, there is a further need and a demand for an ignition material that not only desirably adheres to an associated inflator apparatus surface but also has or provides a desirably large surface area.

### SUMMARY OF THE INVENTION

A general objective of the invention is to provide an improved ignition composition. A more particular objective is to provide such an ignition composition which forms a porous igniter substance having a desirably large or increased surface area. In particular the invention is directed to providing an ignition composition which may be used to form a porous igniter substance capable of adhering to an associated inflator apparatus surface.

A more specific objective of the invention is to overcome one or more of the problems described above.

The general object of the invention can be attained, at least in part, through an ignition composition effective to form an igniter substance having a surface area, the ignition composition including a fuel, an oxidizer, a polymeric binder and blowing agent effective, upon decomposition, to increase the surface area of the igniter substance, wherein the ignition composition, upon being heated to a predetermined temperature, forms an igniter substance which is porous and capable of adhering to an associated inflator apparatus surface. In accordance with the invention, the associated inflator apparatus surface may alternatively include at least a portion of a gas generant wafer or tablet, at least a portion of an interior surface of the inflator device such as the inner surface of a hybrid gas storage container, at least a portion of an electrical squib, at least a portion of a surface of a damper pad, and combinations thereof.

The prior art generally fails to provide an ignition composition which may be used to form an igniter substance having a desirably large or increased surface area and which igniter substance readily adheres to an associated inflator apparatus surface such as to form a porous coating thereon.

The invention further comprehends an ignition composition effective to form an igniter substance, the ignition composition including:

about 15 to about 50 composition weight percent of a fuel;

about 50 to about 85 composition weight percent of an oxidizer;

about 1 to about 20 composition weight percent of a polymeric binder; and

about 1 to about 20 composition weight percent of a blowing agent effective, upon decomposition, to increase the surface area of the igniter substance,

wherein the ignition composition, upon being heated to a predetermined temperature, forms an igniter substance which is porous and capable of adhering to an associated inflator apparatus surface.

The invention still further comprehends, in accordance with one preferred embodiment, a gas generant material for use in an automotive safety restraint system including a porous igniter coating that adheres to at least a portion of a surface of the gas generant material. In accordance with another preferred embodiment, the invention further comprehends a hybrid gas storage container including a porous igniter coating adhered to an inner surface of the container. The invention still further comprehends, in accordance with yet another preferred embodiment, a damper pad for use in automotive safety restraint system including a porous igniter coating adhered to at least a portion of a surface of the pad.

Other objects and advantages will be apparent to those skilled in the art from the following detailed description taken in conjunction with the appended claims and drawings.

### BRIEF DESCRIPTION OF THE DRAWINGS

FIG. 1 is a cross-section view of a coated gas generant material including a porous igniter coating adhered to at least a portion of a selected surface of a gas generant material, in accordance with one embodiment of the invention.

FIG. 2 is a side-sectional view of a single stage hybrid inflator device including a porous igniter coating adhered to an interior surface, in accordance with one embodiment of the invention.

FIG. 3 is a side sectional view of a single stage inflator device including a damper pad cushion including a porous igniter coating adhered to at least a portion of a surface of the pad, in accordance with one embodiment of the invention.

FIG. 4 is a graphical depiction of combustion chamber pressure as a function of time performance realized with a test inflator in Example 1 and Comparative Example 1, respectively.

### DETAILED DESCRIPTION OF THE INVENTION

The present invention provides an ignition composition effective to form an igniter substance desirable for use in an inflator device of an inflatable restraint system. More particularly, the present invention provides an ignition composition which may be used to form an igniter substance which is not only capable of adhering to an associated inflator apparatus surface but which also has a desirably large or increased surface area.

In accordance with the invention, an ignition composition includes: a fuel; an oxidizer; a polymeric binder; and a blowing agent. Generally, upon being heated to a predetermined temperature, the ignition composition forms an igniter substance that is porous and capable of adhering to an associated inflator apparatus surface. The blowing agent is generally effective, upon decomposition, to suitably increase the surface area of the igniter substance.

Those skilled in the art and guided by the teachings herein provided will appreciate that the invention can desirably be applied or practice in conjunction with various ignition formulations such as may find application in inflatable restraint systems. In particular, the invention desirably can be applied to various igniter formulations such as incorporate or employ a selected fuel and oxidizer.

For example, suitable fuel materials in accordance with certain preferred embodiments of the invention include one or more metals, metal hydrides, metalloids, gas producing organic compounds, gas producing inorganic compounds, and polymeric binders. In accordance with certain preferred embodiments, it is desirable that the fuel material employed in the ignition composition be in the form of a finely divided particulate or a powdered material. Suitable metal fuels for use in the invention include, but are not limited to, aluminum, magnesium, alloys of aluminum and magnesium, and combinations thereof. In accordance with certain preferred embodiments, the fuel desirably is an alloy of aluminum and magnesium. Examples of suitable metalloids for use in the practice of the invention include, but are not limited to, boron, silicon and the like. A suitable gas producing organic compound in accordance with certain preferred embodiments of the invention is guanidine nitrate.

Typically, the ignition composition of the invention contains an amount of fuel effective to result in efficient ignition of an associated gas generant material. More particularly, the ignition composition of the invention typically includes about 15 to about 50 composition weight percent of a fuel.

Suitable oxidizer materials in accordance with certain preferred embodiments of the invention include one or more alkali and alkaline earth metal nitrites, nitrates, chlorates, and perchlorates, ammonium nitrate, ammonium perchlorate, transition metal oxides, hydroxide, carbonates, nitrates, and perchlorates, and transition metal complex nitrates, nitrites, and perchlorates, and fluoropolymers, for example. In accordance with certain preferred embodiments of the invention, the ignition composition contains potassium nitrate oxidizer. Generally, in the practice of the invention, the ignition composition includes about 50 to about 85 composition weight percent oxidizer.

As identified above, the ignition composition of the invention also desirably includes a polymeric binder. The polymeric binder desirably imparts adhesive properties to the ignition composition effective to adhere an igniter substance formed by or resulting from the subject ignition composition to an associated surface such as an inflator apparatus surface.

Various polymeric binder materials have been found to be suitable for use in the ignition compositions of the present inventions. Examples of suitable polymeric binders include, but are not limited to, modified cellulose polymers such as, for example, hydroxypropyl cellulose, acrylate polymers such as, for example, polyacrylate polymers, acrylamide polymers, and combinations thereof. In accordance with certain preferred embodiments, the ignition composition includes hydroxypropyl cellulose polymeric binder. In accordance with another preferred embodiment of the invention, the ignition composition advantageously includes a polymeric binder containing an aqueous emulsion of polyacrylate polymers. In particular, modified cellulose polymer and polyacrylate polymer binders can advantageously be utilized in accordance with the present invention at least in part due to their solubility in environmentally friendly solvents which dry rapidly such as, for example, alcohols. Polyacrylate polymeric binders can advantageously be utilized in certain embodiments of the invention at least in part due to their desirable level of adhesion to select surfaces and durability when exposed to vibrational energy.

Desirably, the amount of polymeric binder included in the ignition composition is selected to achieve an acceptable level of adhesion with an associated inflator apparatus surface. Advantageously, the ignition composition includes about 1 to about 20 composition weight percent of polymeric binder.

The ignition composition of the invention further includes a blowing agent. Suitable blowing agents for use in the practice of the invention generally include those blowing agent materials that decompose to gaseous species when subjected to heat. In practice, those blowing agents that at least partially decompose into gas at temperatures below the autoignition temperature of the ignition composition are preferred. Typically, such decomposition temperatures are less than 350° C. such that the ignition composition is required to only be heated to temperatures below 350° C. in order to effect decomposition of the included blowing agent. Those blowing agents that decompose at temperatures between about 100° C. and 300° C. are believed to be most useful and desirable in the practice of the invention.

For certain desired embodiments, such as when an ignition composition in accordance with the invention is applied to at least a portion of a surface a gas generant tablet or wafer, the ignition composition typically includes a blowing agent that decomposes at a temperature less than the autoignition temperature of the gas generant tablet or wafer. Typically, those blowing agents that decompose at temperatures below about 200° C. are believed to be most useful and desirable in the practice of such embodiments.

Furthermore, while the use of a blowing agent that decomposes into all gaseous species is generally preferred, the broader practice of the invention is not necessarily so limited, provided, that any resulting solid decomposition products do not substantially inhibit combustion of the ignition composition or are otherwise detrimental to operation or use of such compositions or devices which include such compositions. Examples of useful blowing agents that typically produce or result in only gaseous products include: aminoguanidine bicarbonate, ammonium oxalate, azodicarbonamide, ammonium carbonate, ammonium carbamate, ammonium bicarbonate, 4,4′-oxydibenzene hydrazide, p-toluene sulfonyl semicarbazide and organic acids. Additional useful blowing agents that generally decompose leaving some solids include: alkali and alkaline earth metal carbonates or bicarbonates, such as basic copper carbonate, metal ammine carbonates such as copper diammine carbonate, and metal ammine salts of organic acids such as copper diammine oxalate, and metal salts of organic acids, for example. In accordance with certain preferred embodiments, the blowing agent included in the ignition composition is aminoguanidine bicarbonate.

In general, the invention can desirably be practiced such that the ignition composition includes about 1 to about 20 composition weight percent of a blowing agent.

In addition, ignition compositions in accordance with the invention may advantageously contain or include one or more desensitizing agents such as to desirably desensitize the igniter substance to the effects of one or more stimuli such as friction, impact and electrostatic discharge, for example. Suitable desensitizing agents for use in the practice of the invention include, but are not limited to, bentonite clay, silicon dioxide, aluminum oxide, zirconium oxide, titanium oxide, and mixtures thereof. In accordance with certain preferred embodiments, bentonite clay is included in the ignition composition as a desensitizing agent. Advantageously, the ignition composition may include a desensitizing agent in an amount of up to about 10 composition weight percent.

The invention further comprehends a method for preparing an igniter substance containing the ignition composition as disclosed above. In particular, in accordance with certain preferred embodiments, an igniter substance can be formed by heating an ignition composition of the invention, as described above, to a predetermined temperature effective to at least partially decompose the blowing agent thereby increasing the surface area of the igniter substance by rendering it porous. Generally, the ignition composition can be heated to a predetermined temperature of between about 100° C. and about 200° C., such as between about 130° C. and about 170° C., to at least partially decompose the blowing agent and render the resulting igniter substance porous.

In accordance with one preferred embodiment of the invention, the ignition composition is prepared by stirring a blend of dry components including a fuel, an oxidizer and a blowing agent into a polymer solution, including a polymeric binder dissolved in a carrier solvent such as, for example, acetone, to form a slurry. The ignition composition slurry is then suitably applied to an associated inflator apparatus surface such as by spraying, dipping, rolling, brushing or the like. The ignition composition slurry is then heated to a predetermined temperature to form an igniter substance which is porous and capable of adhering to an associated inflator apparatus surface such as, for example, at least a portion of a surface of a gas generant wafer or tablet, at least a portion of an interior surface of an inflator device, at least a portion of a surface of an electrical squib, and/or at least a portion of a surface of a damper pad.

As will be appreciated by one of skill in the art and guided by the teachings herein provided, the ignition composition of the present invention can be utilized in a variety of inflator device in a variety of manners. For example, an ignition composition as disclosed above may be used to form a porous igniter coating adhered to at least a portion of a surface of a gas generant wafer or tablet.

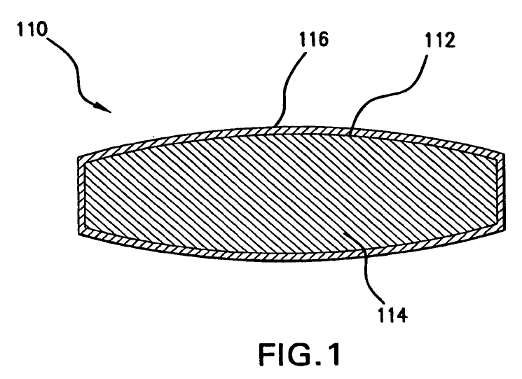

Referring to FIG. 1, a coated gas generant material, generally designated by reference numeral 110, includes an ignition composition applied to at least a portion of a surface 112 of a gas generant tablet 114. The ignition composition, upon heating to a predetermined temperature, forms a porous igniter coating 116 adhered to at least a portion of the surface 112 of the gas generant tablet 114. When ignited, the porous igniter coating 116 causes or results in ignition of the gas generant tablet 114.

As will be appreciated by one of skill in the art and guided by the teachings herein provided, the intimate, direct contact of the porous igniter coating 116 with the gas generant tablet 114 is desirable for efficient ignition of the gas generant material. Such efficiency, in practice, can favorably reduce performance variability in an associate inflator device (not shown).

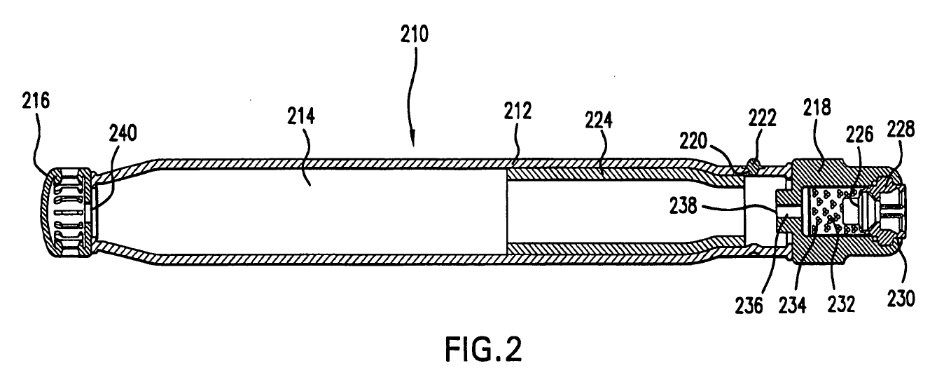

In accordance with another preferred embodiment of the invention, an ignition composition as disclosed above may be utilized to form a porous igniter coating adhered to an inner surface of a hybrid inflator gas storage container. For example, referring to FIG. 2, a hybrid inflator device, generally designated by reference numeral 210, includes an ignition composition of the invention applied to at least a portion of at least one interior surface thereof.

The hybrid inflator assembly 210 includes a pressure vessel 212 including a storage chamber 214. The storage chamber 214 is filled and pressurized with an inert gas such as, for example, argon, helium or nitrogen, or a reactive gas such as, for example, nitrous oxide to a pressure typically in the range of about 2000 psi to about 4000 psi. The hybrid inflator assembly also includes a diffuser 216 and an igniter assembly 218, such as may desirably be appropriately joined or fastened together. The diffuser 216 includes a burst disk 240 which serves to seal the gases contained in the storage chamber 214 from the diffuser 216.

The hybrid inflator assembly 210 further includes a fill port 220 used for gas pressurization, which is integral to the pressure vessel 212 and which, after pressurization, is appropriately sealed such as with a ball weld 222.

The hybrid inflator assembly 210 additionally includes a porous igniter coating 224 in contact with at least a portion of the interior of the pressure vessel 212. In practice and such as described above, an ignition composition in accordance with the invention is desirably applied to at least a portion of a selected interior surface of the pressure vessel 212 and thereafter heated to predetermined temperature to form the porous igniter coating 224.

The igniter assembly 218 includes an igniter squib 226 and a squib adapter or holder 228. Suitably, the squib adapter 228 is mounted to or mated with the igniter assembly 218 via a mounting opening 230. Also included in the igniter assembly 218 is a pyrotechnic charge 232 housed within a container 234 adjacent to an orifice 236, which is sealed by a burst disk 238 attached to the igniter assembly 218.

When actuated, the igniter squib 226 ignites the pyrotechnic charge 232 contained within the container 234. The pyrotechnic charge 232 produces reaction products including a hot flame and gas in a quantity sufficient to burst the container 234 and the burst disk 238. The released gas and hot flame travel through the orifice 236 causing ignition of the porous igniter coating 224. The products formed or resulting from such ignition are brought, through the designed configuration, in direct contact with the gas or gases contained in the storage chamber 214. The subsequent heating of these gases raises the pressure inside the storage chamber 214 to a level sufficient to break the burst disk 240. The heated gases are thereby released into the diffuser 216 and pass out of the hybrid inflator assembly 210 into an associated airbag cushion (not shown).

As will be appreciated by one of skill in the art and guided by the teachings herein, the hybrid inflator assembly 210 eliminates the need for gas heater assembly elements such as a gas generant cup and associated hardware. Such elimination, in practice, can favorably reduce one or more of assembly weight and size as well as improve performance dependability and thus significantly alter, i.e., reduce, costs such as associated with inflator assembly manufacture, installation and/or operation, for example.

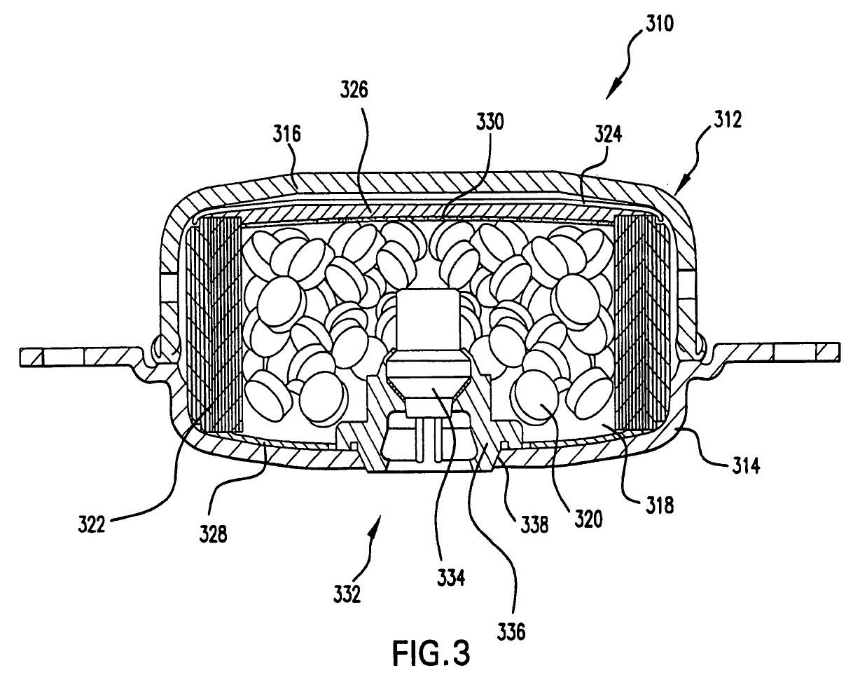

In accordance with an additional preferred embodiment, an ignition composition as disclosed above may be utilized to form a porous igniter coating adhered to at least a portion of a surface of a damper pad. For example, referring to FIG. 3, a single stage inflator device 310 has a generally cylindrical external outline and includes a housing 312 such as formed from two structural components, i.e., a lower shell or base portion 314 and an upper shell or diffuser cap portion 316, such as may desirably be appropriately joined or fastened together.

The housing 312 is configured to define a generally cylindrical chamber, here designated by reference numeral 318. The chamber 318 contains or houses a supply of gas generant material 320, such as composed of a pyrotechnic, such as is known in the art, in a desired selected form. A filter assembly 322 surrounds the gas generant material 320.

The inflator device 310 includes a retainer 324, a diffuser damper pad cushion 326 and a base damper pad cushion 328 which serve to prevent undesired rattle or contact of the gas generant material 320 within the inflator device 310. In practice and such as described above, the diffuser damper pad cushion 326 and/or the base damper pad cushion 328 can be treated with an igniter composition as described above that has been heated to a predetermined temperature to form a porous igniter coating on at least a portion of a surface of the damper pad(s). For example, damper pad cushion 326 can include a porous igniter coating 330 adhered to at least a portion of a surface of the pad.

The inflator device 310 further includes an igniter assembly, generally designated by reference numeral 332 such as in the form of an igniter squib 334 and a squib adapter or holder 336. Suitably, the igniter squib 334 is mounted to or mated with the housing 312 in a location within the chamber 318 via a mounting opening 338.

When actuated, the squib 334 causes ignition of the porous igniter coating 332 of the diffuser damper pad cushion 326. The products formed or resulting for such ignition are, through the designed configuration, in direct contact with the gas generant material 320 contained within the chamber 318 such as to result in the ignition and reaction of the gas generant material 320. The gases produced or formed by such reaction then passes out of the inflator device 310 into an associated airbag cushion (not shown).

As will be appreciated, the inflator assembly 310 eliminates the need for assembly elements such as an igniter cup and/or an igniter tube to house or contain the igniter substance. Such elimination, in practice, can favorably reduce assembly weight, size and/or performance dependability and thus significantly alter, i.e., reduce, costs such as associated with the inflator assembly manufacture, installation and/or operation, for example.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

An ignition composition (Example 1) in accordance with the invention and as shown in TABLE 1, below, was prepared by dissolving hydroxypropyl cellulose polymeric binder in a carrier solvent to form a polymer solution. Dry ingredients including a fuel containing boron and a 50/50 aluminum/magnesium alloy, potassium nitrate oxidizer and bentonite clay desensitizing agent and aminoguanidine bicarbonate were mixed to form a precursor blend. The precursor blend was thoroughly mixed into the polymer solution to form an ignition composition slurry. The ignition slurry was sprayed onto the surface of a standard gas generant table having a diameter of 0.25 inch (0.64 cm) and a thickness of 0.070 inch (0.18 cm) in a tumble coating apparatus at a 2.0 wt % level (after heating). The coated gas generant tablets were dried at approximately 140° C. to remove the carrier solvent, decompose the blowing agent present in the ignition composition and, in accordance with the invention, form a porous igniter coating on the gas generant tablets.

A comparative ignition composition (Comparative Example 1, “CE 1”) as shown in TABLE 1, below was prepared in the same manner, however, without the aminoguanidine bicarbonate blowing agent. The comparative ignition slurry was sprayed onto the surface of a standard gas generant tablet having a diameter of 0.25 inch (0.64 cm) and a thickness of 0.70 inch (0.18 cm) in a tumble coating apparatus at a 2.0 wt % level (after heating). The coated gas generant tablets were dried at approximately 140° C. to remove the carrier solvent and form a comparative igniter coating on the gas generant tablets. After heating, the porous igniter coating in accordance with invention (Example 1) and the comparative igniter coating (CE 1) had the same composition.

TABLE 1

| | | Composition Wt. % | |
|---|---|---|---|
| Ingredient | | Example 1 | CE 1 |
| 50/50 Al/Mg alloy | Fuel | 11.6 | 12.9 |
| Boron | Fuel | 11.3 | 12.5 |
| Potassium nitrate | Oxidizer | 57.7 | 64.1 |
| Hydroxypropyl cellulose | Polymeric binder | 2.7 | 3.0 |
| Aminoguanidine | Blowing agent | 10.0 | 0.0 |
| bicarbonate | | | |
| Bentonite clay | Desensitizing agent | 6.7 | 7.5 |
| TOTAL | | 100.0 | 100.0 |

The coated gas generant materials of Example 1 and Comparative Example 1 were each tested to determine the level of coating retention by in each case loading 80 grams of the respective coated gas generant tablets onto a 25 mesh screen and then subjecting the coated gas generant tablets in each case to vibration for five minutes. The coated gas generant tablets were weighed before and after vibration in each case and the loss of igniter coating was calculated for each sample. TABLE 2, below, reports the results in terms of percentage retention of the igniter coating for each sample.

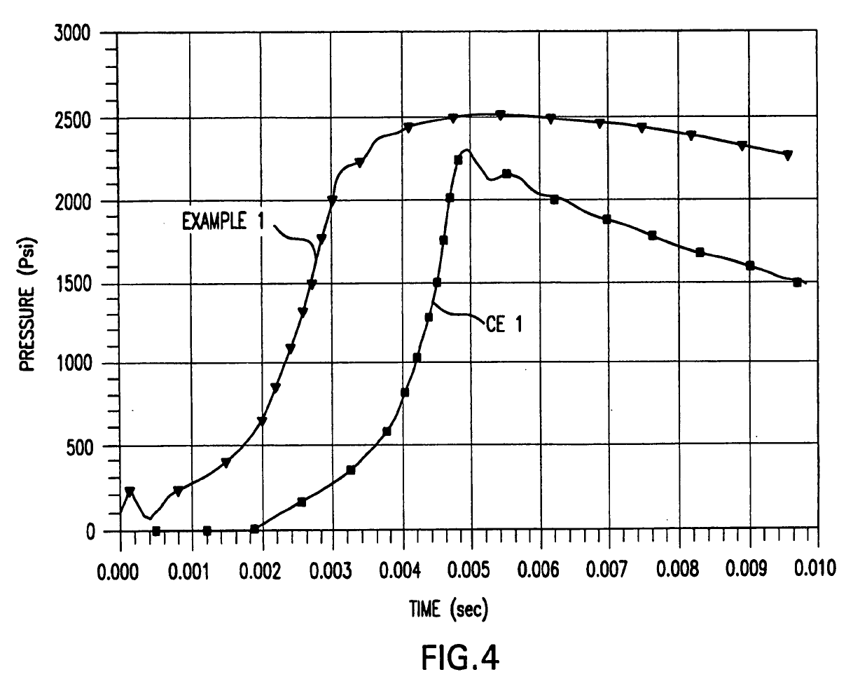

The coated gas generant materials of Example 1 and Comparative Example 1 were each also tested to determine the level of performance as manifested by delay in ignition by loading 32 grams of the respective coated gas generant tablets into a test inflator device. The test inflator device in each case was mated to a 100 liter tank equipped with a pressure transducer to measure the pressure within the tank. The test inflator device was also provided with a pressure transducer to measure pressure within the combustion chamber of the test inflator device. The test inflator device in each case was fired into the tank and combustion chamber pressure vs. time performance was recorded by means of a data collection system. The period of time until a first indication of pressure in the pressure vs. time curve is the delay reported in TABLE 2, below. The pressure vs. time performance curves collected for each sample are shown in FIG. 4.

TABLE 2

| Sample | % Retention | Delay (milliseconds) |
|---|---|---|
| Example 1 | 96.77 | 1 |
| CE 1 | 95.80 | 3 |

The data in TABLE 2 shows that the porous igniter coating formed from an ignition composition in accordance with the invention (Example 1) demonstrated at least comparable and slightly improved adhesion to the gas generant surface over the igniter coating formed from a comparable ignition composition prepared without a blowing agent (CE 1).

The data in TABLE 2 also shows that the porous igniter coating formed from an ignition composition in accordance with the invention (Example 1) demonstrated a significantly decreased delay in ignition and, therefore an improvement in performance, over the igniter coating formed form a comparable ignition composition prepared without a blowing agent (CE 1).

As discussed above, while it may be desirable to increase the extent of adhesion of an ignition material to a selected surface in order to reduce or prevent undesirable loss of the ignition material from the surface and the extent of ignition material adhesion can typically be improved by including a polymeric binder in the ignition composition, such an increase in the polymer content of an ignition composition normally has associated with it a decrease in performance as manifested by delay in ignition.

Referring to the combustion pressure vs. time curve shown in FIG. 4, the graph shows that from the point of firing (Time=0) to the point of a first indication of pressure approximately 1 millisecond elapsed for Example 1 whereas for Comparative Example (CE 1) nearly 3 milliseconds elapsed. Thus, as shown in TABLE 2 and FIG. 4, the loss of performance typically observed when the polymeric binder concentration of an ignition composition is increased can desirably be offset in accordance with the invention by increasing the surface area of the igniter coating such as by including a blowing agent in the associated ignition composition.

Thus, the invention provides an improved ignition composition which forms a porous igniter substance having a desirably large or increased surface area. In particular, the invention provides an improved ignition composition which may be used to form a porous igniter substance capable of adhering to an associated inflator apparatus surface.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method comprising:
applying an ignition composition comprising;
a fuel material including at least one of a group consisting of metals, metal hydrides and metalloids,
an oxidizer,
a polymeric binder and
a blowing agent,
onto an associated inflator apparatus surface forming an igniter substance having a surface area, and
heating the applied ignition composition to a predetermined temperature to decompose the blowing agent forming a porous igniter substance comprising the fuel material, the oxidizer and the binder and adhering the porous igniter substance to the associated inflator apparatus surface, the porous igniter substance having an increased surface area as compared to the igniter substance prior to decomposition of the blowing agent.

2. The method of claim 1 wherein the associated inflator apparatus surface is selected from the group consisting of at least a portion of a surface of a gas generant material, at least a portion of an interior surface of an inflator device, at least a portion of a surface of an electrical squib, at least a portion of a surface of a damper pad, and combinations thereof.

3. The method of claim 2 wherein the associated inflator apparatus surface is a surface of a gas generant material comprising a gas generant wafer or tablet.

4. The method of claim 1 wherein the ignition composition additionally comprises a gas generating organic fuel.

5. The method of claim 1 wherein the fuel material comprises a metal fuel selected from the group consisting of aluminum, magnesium, alloys of aluminum and magnesium, and combinations thereof.

6. The method of claim 1 wherein the fuel material comprises an alloy of aluminum and magnesium.

7. The method of claim 6 wherein the ignition composition additionally comprises boron.

8. The method of claim 1 wherein the oxidizer is potassium nitrate.

9. The method of claim 1 wherein the polymeric binder is hydroxypropyl cellulose.

10. The method of claim 1 wherein the blowing agent is aminoguanidine bicarbonate.

11. The method of claim 1 wherein the ignition composition additionally comprises a desensitizing agent.

12. The method of claim 11 wherein the desensitizing agent is bentonite clay.

13. The method of claim 1 wherein the applying of the ignition composition onto the associated inflator apparatus surface comprises coating qt least a portion of the associated inflator apparatus surface with the ignition composition.

14. The method of claim 1 wherein the ignition composition comprises:
about 15 to about 50 composition weight percent of the fuel material;
about 50 to about 85 composition weight percent of the oxidizer;
about 1 to about 20 composition weight percent of the polymeric binder; and
about 1 to about 20 composition weight percent of the blowing agent.

15. A method of making a porous igniter substance onto an associated inflator apparatus surface, the method comprising:
coating an ignition composition onto at least a portion of an associated inflator apparatus surface forming an igniter substance having a surface area, the ignition composition comprising;
about 15 to about 50 composition weight percent of fuel material including at least one of a group consisting of metals, metal hydrides and metalloids;
about 50 to about 85 composition weight percent of an oxidizer;
about 1 to about 20 composition weight percent of a polymeric binder; and
about 1 to about 20 composition weight percent of a blowing agent, and
thermally decomposing the blowing agent forming a porous igniter substance comprising the fuel material, the oxidizer and the binder and adhering the porous igniter substance to the associated inflator apparatus surface, the porous igniter substance having an increased surface area as compared to the igniter substance prior to decomposition of the blowing agent.

16. The method of claim 15 wherein the associated inflator apparatus surface is selected from the group consisting of at least a portion of a surface of a gas generant material, at least a portion of an interior surface of an inflator device, at least a portion of a surface of an electrical squib, at least a portion of a surface of a damper pad, and combinations thereof.

17. The method of claim 16 wherein the associated inflator apparatus surface is a surface of a gas generant material comprising a gas generant wafer or tablet.

18. The method of claim 15 wherein the oxidizer is potassium nitrate.

19. The method of claim 15 wherein the blowing agent is aminoguanidine bicarbonate.

20. A combination comprising:
an ignition composition effective to form an igniter substance having a surface area, the ignition composition comprising:
about 15 to about 50 composition weight percent of a fuel material;
about 50 to about 85 composition weight percent of an oxidizer;
about 1 to about 20 composition weight percent of a polymeric binder; and
about 1 to about 20 composition weight percent of a blowing agent effective, upon decomposition, to increase the surface area of the igniter substance to form a porous igniter substance; and
an associated inflator apparatus surface onto which the ignition composition forms the porous igniter substance adhered thereto, the porous igniter substance having an increased surface area as compared to the igniter substance prior to decomposition of the blowing agent.
